(19) United States
(12) Patent Application Publication
(10) Pub. No.: US 2021/0291736 A1
(43) Pub. Date: Sep. 23, 2021

(54) DISPLAY CONTROL APPARATUS, DISPLAY CONTROL METHOD, AND COMPUTER-READABLE STORAGE MEDIUM STORING PROGRAM

(71) Applicant: HONDA MOTOR CO., LTD., Tokyo (JP)

(72) Inventors: Masafumi HIGASHIYAMA, Wako-shi (JP); Shinji KAWAKAMI, Wako-shi (JP)

(21) Appl. No.: 17/185,113

(22) Filed: Feb. 25, 2021

(30) Foreign Application Priority Data
Mar. 17, 2020 (JP) 2020-046809

(51) Int. Cl. B60R 1/00; G02B 27/01; G02B 27/00

(52) U.S. Cl. CPC B60R 1/001; G02B 27/0101; G02B 2027/014; B60R 2300/308; B60R 2300/8093; G02B 27/0093

(57) ABSTRACT

A display control apparatus comprising: a display control unit configured to display an image such that the image is superimposed on a visual field region of a driver of a vehicle; and a detection unit configured to analyze a line of sight of the driver and detect a viewpoint of the driver in the visual field region that is obtained as a result of the analysis, wherein the display control unit subjects a predetermined region in the visual field region to display control, and based on a result of determination of overlapping between the predetermined region in the visual field region and the viewpoint of the driver detected by the detection unit, if the overlapping satisfies a condition, the display control unit changes a mode of the display of the image.

### CROSS-REFERENCE TO RELATED APPLICATION(S)

This application claims priority to and the benefit of Japanese Patent Application No. 2020-046809 filed on Mar. 17, 2020, the entire disclosure of which is incorporated herein by reference.

### BACKGROUND OF THE INVENTION

### Field of the Invention

The present invention relates to a display control apparatus, a display control method, and a computer-readable storage medium storing a program with which an image can be displayed such that the image is superimposed on a visual field region of a driver.

### Description of the Related Art

Japanese Patent Laid-Open No. 2005-135037 describes that if it is inferred that a driver has recognized content of a displayed warning, the method for displaying this warning is changed (a reduction in brightness, a change in the display position, a stop of the display etc.). International Publication No. 2016/166791 describes that an actual line-of-sight distribution of a driver and an ideal line-of-sight distribution are displayed.

### SUMMARY OF THE INVENTION

The present invention provides a display control apparatus, a display control method, and a computer-readable storage medium storing a program that effectively urge a driver to closely observe a predetermined region in a visual field region.

The present invention in its first aspect provides a display control apparatus includes: a display control unit configured to display an image such that the image is superimposed on a visual field region of a driver of a vehicle; and a detection unit configured to analyze a line of sight of the driver and detect a viewpoint of the driver in the visual field region that is obtained as a result of the analysis, wherein the display control unit subjects a predetermined region in the visual field region to display control, and based on a result of determination of overlapping between the predetermined region in the visual field region and the viewpoint of the driver detected by the detection unit, if the overlapping satisfies a condition, the display control unit changes a mode of the display of the image.

The present invention in its second aspect provides a display control method includes: displaying an image such that the image is superimposed on a visual field region of a driver of a vehicle; and analyzing a line of sight of the driver and detecting a viewpoint of the driver in the visual field region that is obtained as a result of the analysis, wherein a predetermined region in the visual field region is subjected to display control, and based on a result of determination of overlapping between the predetermined region in the visual field region and the detected viewpoint of the driver, if the overlapping satisfies a condition, a mode of the display of the image is changed.

The present invention in its third aspect provides a computer-readable storage medium storing a program for causing a computer to perform functions of: displaying an image such that the image is superimposed on a visual field region of a driver of a vehicle; and analyzing a line of sight of the driver and detecting a viewpoint of the driver in the visual field region that is obtained as a result of the analysis, wherein a predetermined region in the visual field region is subjected to display control, and based on a result of determination of overlapping between the predetermined region in the visual field region and the detected viewpoint of the driver, if the overlapping satisfies a condition, a mode of the display of the image is changed.

According to the present invention, the driver can be effectively urged to closely observe a predetermined region in a visual field region.

### BRIEF DESCRIPTION OF THE DRAWINGS

FIG. 1 is a block diagram of a control apparatus for a vehicle (travel control apparatus).

FIG. 2 is a diagram showing functional blocks of a control unit.

FIG. 3 is a diagram showing a visual field region seen from a driver.

FIG. 4 is a diagram showing the visual field region seen from the driver.

FIG. 5 is a flowchart showing display control processing.

FIG. 6 is a flowchart showing display control processing.

FIG. 7 is a flowchart showing display control processing.

FIG. 8 is a flowchart showing display control processing.

FIG. 9 is a flowchart showing display control processing.

FIG. 10 is a flowchart showing display control processing.

FIG. 11 is a flowchart showing display control processing.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

Neither patent document mentions controlling the display mode of a display for the driver in order to urge the driver to closely observe a predetermined region.

According to one aspect of the present invention, the driver can be effectively urged to closely observe a predetermined region in a visual field region.

### First Embodiment

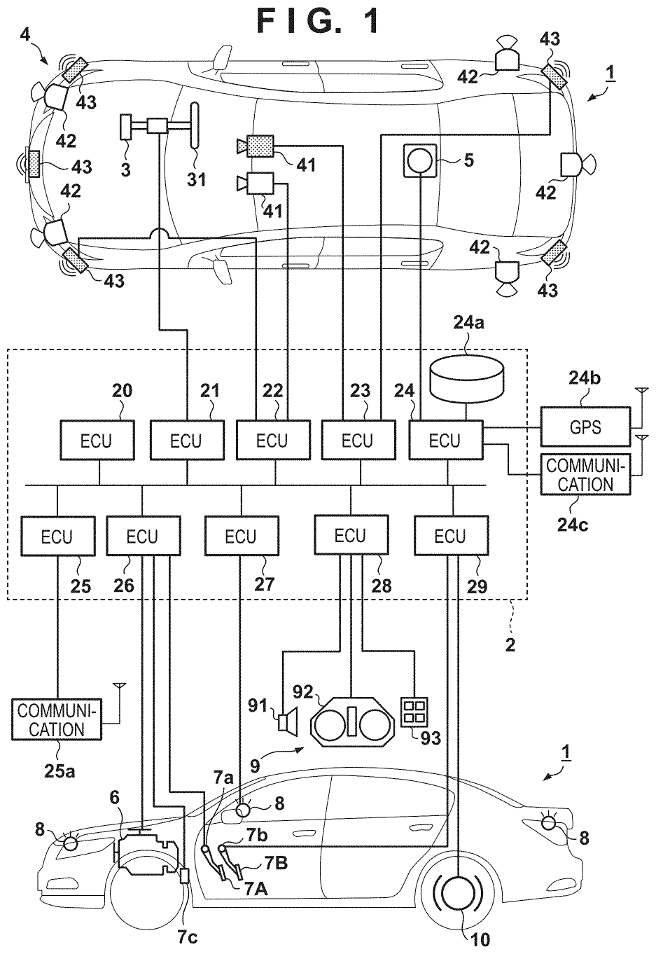

FIG. 1 is a block diagram of a control apparatus for a vehicle (travel control apparatus) according to an embodiment of the present invention, and controls a vehicle 1. In FIG. 1, an overview of the vehicle 1 is shown in a plan view and a side view. As an example, the vehicle 1 is a sedan type four-wheeled passenger car. Note that although the present embodiment will describe, as an example configuration of the vehicle 1, a vehicle configured to be able to realize automated driving and driving assistance functions, the configuration of the vehicle 1 is not limited to that described below as long as it is equipped with a later-described head-up display (HUD) configuration.

The control apparatus in FIG. 1 includes a control unit 2. The control unit 2 includes a plurality of ECUs 20 to 29, which are communicably connected to each other by a vehicle network. Each of the ECUs includes a processor, which is typified by a CPU, a storage device such as a semiconductor memory, an interface for an external device, and so on. The storage device stores programs to be executed by the processor, data to be used in processing by the processor, and so on. Each of the ECUs may include a plurality of processors storage devices, interfaces, and so on. The configuration of the control apparatus in FIG. 1 may be a computer that carries out the present invention that relates to a program.

Functions or the like assigned to the respective ECUs 20 to 29 will be described below. Note that the number of ECUs and functions assigned thereto can be designed as appropriate, and can be further segmented than in the present embodiment, or can be integrated.

The ECU 20 executes control associated with automated driving of the vehicle 1. During automated driving, the ECU 20 automatically controls at least either steering or acceleration/deceleration of the vehicle 1. In a later-described control example, the ECU 20 automatically controls both steering and acceleration/deceleration.

The ECU 21 controls an electric power steering device 3. The electric power steering device 3 includes a mechanism for steering front wheels in accordance with a driver's driving operation (steering operation) to a steering wheel 31. The electric power steering device 3 also includes a motor that exerts a driving force for assisting in the steering operation or automatically steering the front wheels, a sensor for detecting a steering angle, and so on. If the driving state of the vehicle 1 is automated driving, the ECU 21 automatically controls the electric power steering device 3 in response to an instruction from the ECU 20, and controls the traveling direction of the vehicle 1.

The ECUs 22 and 23 control detection units 41 to 43 for detecting the surrounding situation of the vehicle and perform information processing on their detection results. The detection units 41 are cameras (hereinafter referred to as “cameras 41” in some cases) for capturing images of the front of the vehicle 1. In the present embodiment, the detection units 41 are attached to the vehicle interior on the inner side of the windscreen, at a front portion of the roof of the vehicle 1. Analysis of the images captured by the cameras 41 makes it possible to extract an outline of a target and extract a lane marker (white line etc.) of a traffic lane on a road.

The detection units 42 are Light Detection and Ranging (LIDARs), and detect a target around the vehicle 1 and measure the distance to the target. In the present embodiment, five detection units 42 are provided, one on each corner of the front part of the vehicle 1, one at the center of the rear part, and one on each side of the rear part. The detection units 43 are millimeter wave radars (hereinafter referred to as “radars 43” in some cases), and detect a target around the vehicle 1 and measure the distance to the target. In the present embodiment, five radars 43 are provided, one at the center of the front part of the vehicle 1, one at each corner of the front part, and one on each corner of the rear part.

The ECU 22 controls one of the cameras 41 and the detection units 42 and performs information processing on their detection results. The ECU 23 controls the other camera 41 and the radars 43 and performs information processing on their detection results. As a result of two sets of devices for detecting the surrounding situation of the vehicle being provided, the reliability of the detection results can be improved. Also, as a result of different types of detection units such as cameras and radars being provided, manifold analysis of the surrounding environment of the vehicle is enabled.

The ECU 24 controls a gyroscope sensor 5, a GPS sensor 24b, and a communication device 24c, and performs information processing on their detection results or communication results. The gyroscope sensor 5 detects rotational motion of the vehicle 1. A path of the vehicle 1 can be determined based on the results of detection by the gyroscope sensor 5, the wheel speed, or the like. The GPS sensor 24b detects the current position of the vehicle 1. The communication device 24c wirelessly communicates with a server that provides map information, traffic information, and weather information, and acquires such information. The ECU 24 can access a database 24a of map information that is built in the storage device, and the ECU 24 searches for a route from the current location to a destination, for example. Note that a database of the aforementioned traffic information, weather information, or the like may also be built in the database 24a.

The ECU 25 includes a communication device 25a for vehicle-to-vehicle communication. The communication device 25a wirelessly communicates with other vehicles in the surrounding area and exchanges information between the vehicles.

The ECU 26 controls a power plant 6. The power plant 6 is a mechanism that outputs a driving force for rotating drive wheels of the vehicle 1, and includes, for example, an engine and a transmission. For example, the ECU 26 controls the output of the engine in response to the driver's driving operation (acceleration pedal operation or accelerating operation) detected by an operation detection sensor 7a provided on an acceleration pedal 7A, and switches the gear ratio of the transmission based on information such as vehicle speed detected by a vehicle speed sensor 7c. If the driving state of the vehicle 1 is automated driving, the ECU 26 automatically controls the power plant 6 in response to an instruction from the ECU 20 and controls acceleration/deceleration of the vehicle 1.

The ECU 27 controls lighting devices (headlight, tail light etc.) including direction indicators 8 (blinkers). In the example in FIG. 1, the direction indicators 8 are provided at front portions, door mirrors, and rear portions of the vehicle 1.

The ECU 28 controls an input/output device 9. The input/output device 9 outputs information to the driver and accepts input of information from the driver. A sound output device 91 notifies the driver of information using a sound. A display device 92 notifies the driver of information by means of a display of an image. The display device 92 is, for example, disposed in front of the driver seat and constitutes an instrument panel or the like. Note that although an example of using a sound and a display is described here, information may alternatively be notified using a vibration and/or light. Further, information may be notified by combining two or more of a sound, a display, a vibration, and light. Furthermore, the combination may be varied or the notification mode may be varied in accordance with the level (e.g., degree of urgency) of information to be notified. The display device 92 includes a navigation device.

An input device 93 is a switch group that is disposed at a position at which it can be operated by the driver and gives instructions to the vehicle 1, and may also include a sound input device.

The ECU 29 controls brake devices 10 and a parking brake (not shown). The brake devices 10 are, for example, disc brake devices and provided on the respective wheels of the vehicle 1, and decelerate or stop the vehicle 1 by applying resistance to the rotation of the wheels. For example, the ECU 29 controls operations of the brake devices 10 in response to the driver's driving operation (braking operation) of the driver detected by an operation detection sensor 7b provided on a brake pedal 7B. If the driving state of the vehicle 1 is automated driving, the ECU 29 automatically controls the brake devices 10 in response to an instruction from the ECU 20 and controls deceleration and stop of the vehicle 1. The brake devices 10 and the parking brake can also be operated to maintain the stopped state of the vehicle 1. If the transmission of the power plant 6 includes a parking lock mechanism, it can also be operated to maintain the stopped state of the vehicle 1.

A description will be given of control associated with automated driving of the vehicle 1 executed by the ECU 20. If an instruction of a destination and automated driving is given by the driver, the ECU 20 automatically controls the travel of the vehicle 1 to a destination in accordance with a guided route searched for by the ECU 24. During automated control, the ECU 20 acquires information (external information) associated with the surrounding situation of the vehicle 1 from the ECUs 22 and 23, and gives instructions to the ECUs 21, 26, and 29 based on the acquired information to control steering and acceleration/deceleration of the vehicle 1.

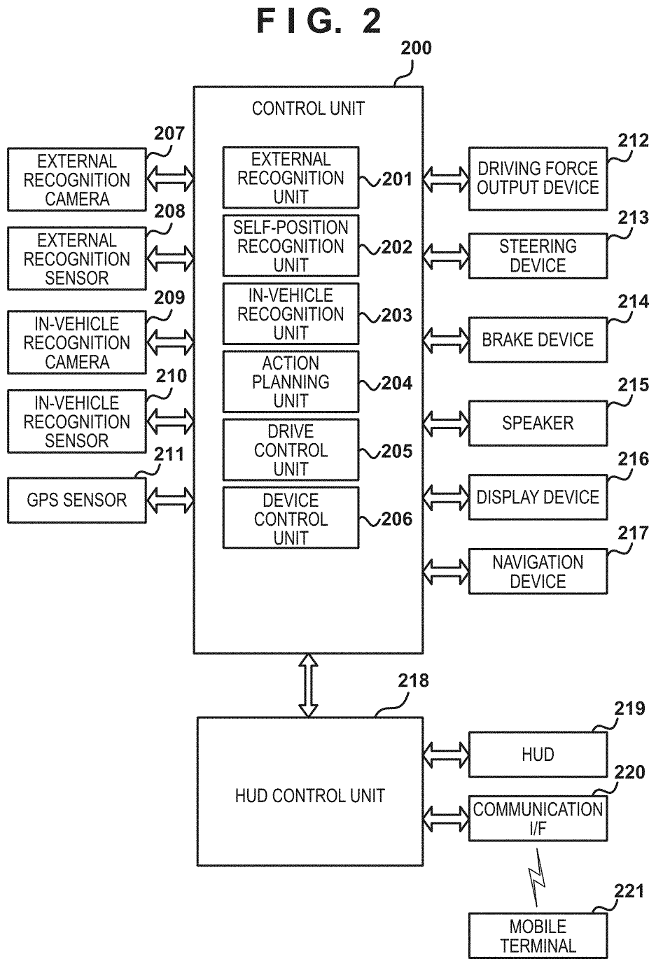

FIG. 2 is a diagram showing functional blocks of the control unit 2. A control unit 200 corresponds to the control unit 2 in FIG. 1, and includes an external recognition unit 201, a self-position recognition unit 202, an in-vehicle recognition unit 203, an action planning unit 204, a drive control unit 205, and a device control unit 206. Each block is realized by one or more of the ECUs shown in FIG. 1.

The external recognition unit 201 recognizes external information regarding the vehicle 1 based on signals from external recognition cameras 207 and external recognition sensors 208. Here, the external recognition cameras 207 are, for example, the cameras 41 in FIG. 1, and the external recognition sensors 208 are, for example, the detection units 42 and 43 in FIG. 1. The external recognition unit 201 recognizes, for example, a scene of an intersection, a railroad crossing, a tunnel, or the like, a free space such as a road shoulder, and behavior (speed, traveling direction) of other vehicles, based on signals from the external recognition cameras 207 and the external recognition sensors 208. The self-position recognition unit 202 recognizes the current position of the vehicle 1 based on a signal from the GPS sensor 211. Here, the GPS sensor 211 corresponds to the GPS sensor 24b in FIG. 1, for example.

The in-vehicle recognition unit 203 identifies an occupant of the vehicle 1 and recognizes the state of the occupant based on signals from an in-vehicle recognition camera 209 and an in-vehicle recognition sensor 210. The in-vehicle recognition camera 209 is, for example, an infrared camera installed on the display device 92 inside the vehicle 1, and detects a line-of-sight direction of the occupant, for example. The in-vehicle recognition sensor 210 is, for example, a sensor for detecting a biological signal of the occupant. The in-vehicle recognition unit 203 recognizes that the occupant is in a dozing state or a state of doing work other than driving, based on those signals.

The action planning unit 204 plans actions of the vehicle 1, such as an optimal path and a risk-avoiding path, based on the results of recognition by the external recognition unit 201 and the self-position recognition unit 202. The action planning unit 204 plans actions based on an entrance determination based on a start point and an end point of an intersection, a railroad crossing, or the like, and prediction of behavior of other vehicles, for example. The drive control unit 205 controls a driving force output device 212, a steering device 213, and a brake device 214 based on an action plan made by the action planning unit 204. Here, for example, the driving force output device 212 corresponds to the power plant 6 in FIG. 1, the steering device 213 corresponds to the electric power steering device 3 in FIG. 1, and the brake device 214 corresponds to the brake device 10.

The device control unit 206 controls devices connected to the control unit 200. For example, the device control unit 206 controls a speaker 215 to cause the speaker 215 to output a predetermined sound message, such as a message for warning or navigation. Also, for example, the device control unit 206 controls a display device 216 to cause the display device 216 to display a predetermined interface screen. The display device 216 corresponds to the display device 92, for example. Also, for example, the device control unit 206 controls a navigation device 217 to acquire setting information in the navigation device 217.

The control unit 200 may also include functional blocks other than those shown in FIG. 2 as appropriate, and may also include, for example, an optimal path calculation unit for calculating an optimal path to the destination based on the map information acquired via the communication device 24c. Also, the control unit 200 may also acquire information from anything other than the cameras and sensors shown in FIG. 2, and may acquire, for example, information regarding other vehicles via the communication device 25a. Also, the control unit 200 receives detection signals from various sensors provided in the vehicle 1, as well as the GPS sensor 211. For example, the control unit 200 receives detection signals from a door opening/closing sensor and a mechanism sensor on a door lock that are provided in a door portion of the vehicle 1, via an ECU configured in the door portion. Thus, the control unit 200 can detect unlocking of the door and a door opening/closing operation.

A head-up display (HUD) control unit 218 controls a head-up display (HUD) 219 that is attached to the vehicle interior near the windscreen of the vehicle 1. The HUD control unit 218 and the control unit 200 can communicate with each other, and the HUD control unit 218 acquires, for example, captured image data obtained by the external recognition cameras 207 via the control unit 200. The HUD 219 projects an image onto the windscreen under the control of the HUD control unit 218. For example, the HUD control unit 218 receives captured image data obtained by the external recognition cameras 207 from the control unit 200, and generates image data to be projected by the HUD 219 based on the captured image data. This image data is, for example, image data to be overlapped (superimposed) with the landscape that can be seen from the driver through the windscreen. Due to the projection onto the windscreen by the HUD 219, the driver can feel that an icon image (destination information etc.) for navigation is overlapped with the landscape of a road ahead, for example. The HUD control unit 218 can communicate with an external device via a communication interface (I/F) 220. The external device is, for example, a mobile terminal 221 such as a smartphone held by the driver. The communication I/F 220 may be configured such that it can be connected to a plurality of networks, and may be, for example, configured such that it can be connected to the Internet.

Operations in the present embodiment will be described below. When a driver drives a vehicle, the driver has a duty of care to look ahead. In addition, there are regions that require attention in a visual field region that can be visually recognized by the driver through the windscreen, depending on the scenes such as an intersection or a curve.

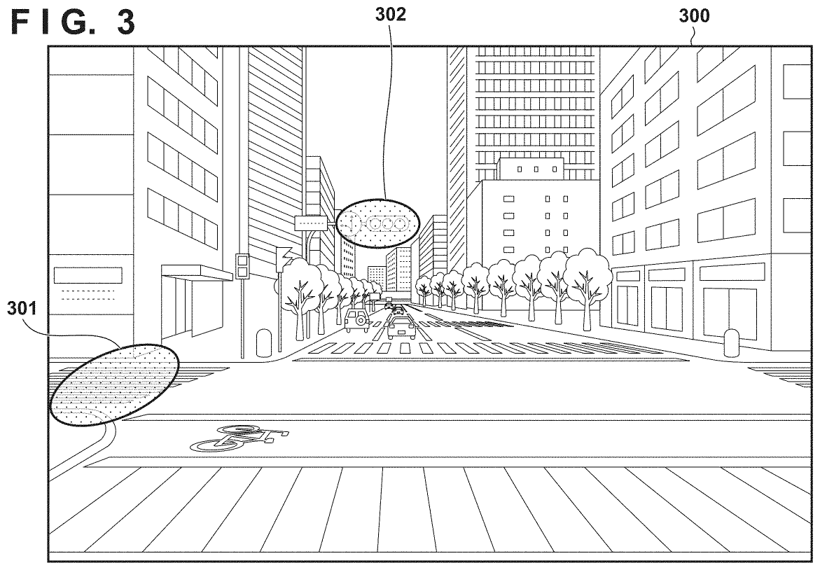

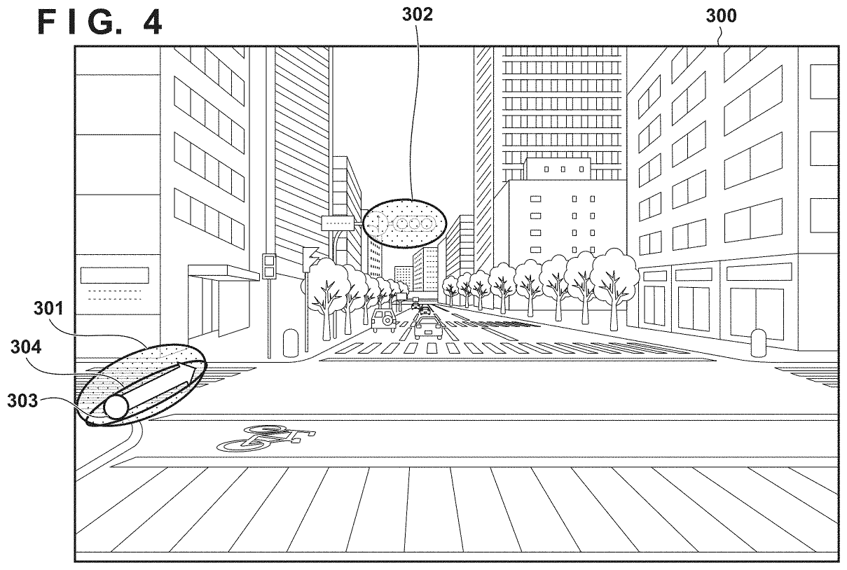

FIGS. 3 and 4 are diagrams for illustrating operations in the present embodiment. FIGS. 3 and 4 show a visual field region that can be visually recognized by the driver through the windscreen. In a visual field region 300 in FIG. 3, regions 301 and 302 are regions that require attention. That is to say, in the scene of an intersection shown in FIG. 3, there is a possibility that a person or the like will jump out from the left or other vehicles enter the intersection, and therefore the region 301 is a region that requires attention. Also, for smooth passage of the vehicle, the region 302, which corresponds to a traffic signal, is a region that requires attention. In the present embodiment, the regions 301 and 302 are identifiably displayed such that the regions 301 and 302 overlap with the landscape on the windscreen by the HUD 219, as shown in FIG. 3. For example, the regions 301 and 302 are displayed as lightly colored translucent regions.

FIG. 4 shows the case where, in the display state in FIG. 3, the driver places a viewpoint at the region 301. A viewpoint 303 is a region corresponding to the driver's viewpoint. That is to say, FIG. 4 shows a situation where the driver places a viewpoint near an area corresponding to a curb in the region 301. Then, as the driver moves the viewpoint in an arrow direction within the region 301, the viewpoint 303 also moves in an arrow direction in the visual field region 300. A viewpoint region 304 represents a region covered by the movement of the viewpoint. In the present embodiment, in the viewpoint region 304, which corresponds to the amount of movement of the viewpoint 303 in the region 301, the identifiable display of the region 301 is canceled only for an area corresponding to the viewpoint region 304. For example, in the translucent display of the region 301, a translucent display of an area corresponding to the viewpoint region 304 is canceled. If the area of the viewpoint region 304 reaches a predetermined ratio of the area of the region 301, the identifiable display of the region 301 is entirely canceled.

Thus, according to the present embodiment, regions that require attention is identifiably displayed as shown in FIG. 3, and the driver can be urged to place a viewpoint at this region. If the driver places a viewpoint at this region, the identifiable display of the region 301 is partially canceled as shown in FIG. 4, and thus the driver can recognize that the driver has placed a viewpoint at a region that requires attention. Furthermore, if the area of the viewpoint region 304 reaches a predetermined ratio of the area of the region 301, the identifiable display of the region 301 is entirely canceled, and thus the driver can be motivated to thoroughly check the region that requires attention.

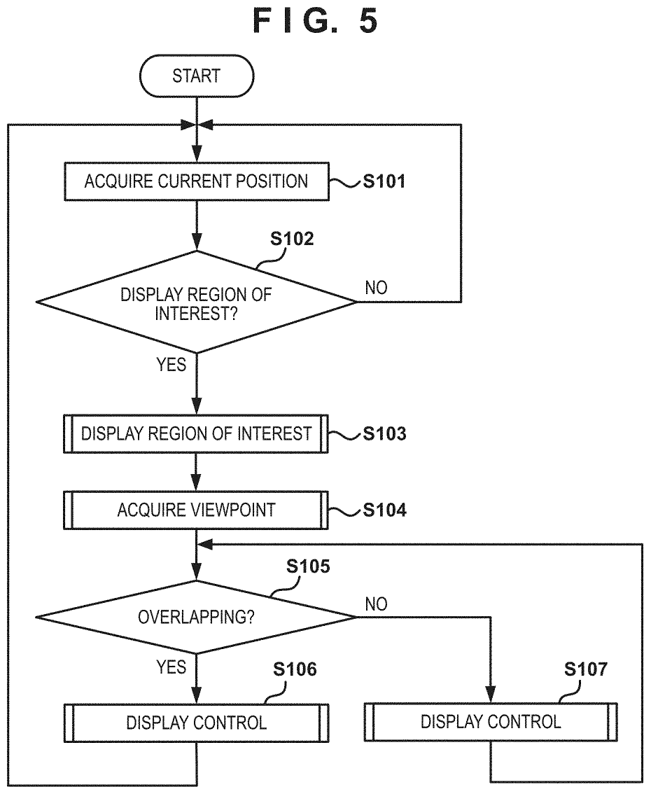

FIG. 5 is a flowchart showing display control processing in the present embodiment. For example, the processing in FIG. 5 is realized by the HUD control unit 218 loading a program from a storage area of a ROM or the like and executing the program. The processing in FIG. 5 is started upon the vehicle 1 starting traveling.

In step S101, the HUD control unit 218 acquires the current position of the vehicle 1. For example, the HUD control unit 218 may acquire the current position of the vehicle 1 from the control unit 200. Then, in step S102, the HUD control unit 218 determines whether or not to display a region of interest based on the current position of the vehicle 1 acquired in step S101. Here, the region of interest corresponds to any of the regions 301 and 302 in FIGS. 3 and 4. In step S102, if a point that requires attention is present in a predetermined distance from the current position of the vehicle 1, the HUD control unit 218 determines to display a region of interest. For example, based on map information acquired from the control unit 200, if a specific scene, such as an intersection or a curve with a predetermine curvature or more, is present in the predetermined distance from the current position of the vehicle 1, the HUD control unit 218 determines to display a region of interest. If, in step S102, it is determined not to display a region of interest, the processing is repeated from step S101. If, in step S102, it is determined to display a region of interest, the processing proceeds to step S103.

Note that points that require attention may be learned in advance for each scene. As a configuration for this purpose, for example, the HUD control unit 218 has a learning unit that includes a GPU, a data analysis unit, and a data accumulation unit. The data accumulation unit accumulates data on the driver's viewpoint position in the visual field region for each scene corresponding to a traveling road or the like, and the data analysis unit analyzes a distribution of the driver's viewpoint in the visual field region. For example, a configuration may be employed in which a skilled driver drives the vehicle in advance, a distribution of this driver's viewpoint is analyzed, and the analysis results are stored for each scene. In this case, the tendency of the distribution of the skilled driver's viewpoint is learned as points that require attention.

Meanwhile, points that require attention may also be learned with any other methods using the tendency of the distribution of a viewpoint of any driver other than a skilled driver in the visual field region. For example, a configuration may be employed in which, based on the tendency of the distribution of a driver's viewpoint in the visual field region, points that the driver tends to overlook but that need to be checked are regarded as points that require attention, and are classified and learned for each scene. For example, if it is analyzed that the viewpoint tends to be extremely distributed in the vicinity of the vehicle in the front thereof when the vehicle moves round a curve (e.g., the driver has a habit of staring an area near the vehicle), a region corresponding to an area far away from the vehicle in the front thereof in the visual field region may be learned as a point that requires attention. At this time, the tendency of the distribution of the aforementioned skilled driver's viewpoint may be used as training data. Each of the above learning results is used as a region of interest if it is decided that the vehicle is traveling in a similar scene.

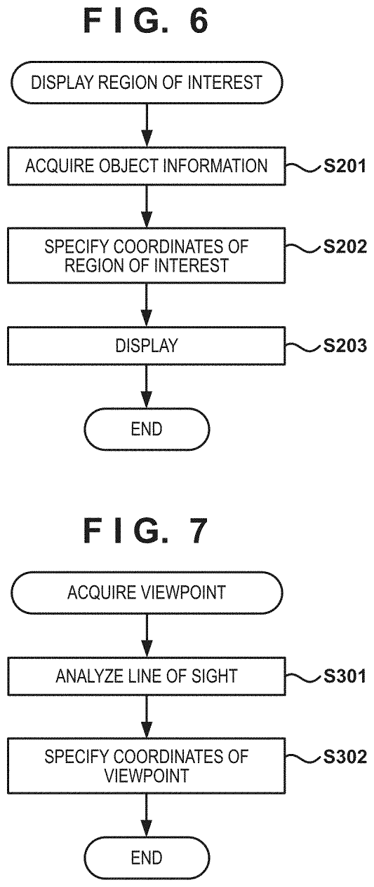

In step S103, the HUD control unit 218 displays the region of interest. FIG. 6 is a flowchart showing processing for displaying the region of interest in step S103. In step S201, the HUD control unit 218 acquires object information. Here, the object information refers to information regarding an object that serves as a reference for specifying the coordinates of the region that requires attention, and is, for example, information regarding an object such as a traffic sign or a traffic signal. The object information is not limited to information regarding an object, and may alternatively be information regarding an area that includes a plurality of objects. For example, the object information may be information regarding an area covering a pedestrian crossing and curbs, such as the region 301 in FIG. 3. For example, the HUD control unit 218 may acquire, via the control unit 200, the object information based on captured image data obtained by the external recognition camera 207 that corresponds to the visual field region 300.

In step S202, the HUD control unit 218 specifies the coordinates of the region of interest in the visual field region 300 that is to be displayed by the HUD, based on the object information acquired in step S201. For example, the HUD control unit 218 acquires image data on the visual field region 300 based on the captured image data obtained by the external recognition camera 207 that corresponds to the visual field region 300, and specifies the coordinates of the region of interest in the visual field region 300 that is to be displayed by the HUD, based on the image data.

In step S203, the HUD control unit 218 generates display data for displaying the region of interest using the HUD, based on the coordinates of the region of interest specified in step S202, and controls the HUD 219 so as to display the region of interest on the windscreen based on the display data. Here, the display data corresponds to any of the regions 301 and 302 in FIG. 3. Also, the HUD control unit 218 generates display data such that the region of interest can be distinguished from other regions by making the region of interest into a lightly colored translucent region, for example. After displaying the region of interest using the HUD, the HUD control unit 218 starts measuring the elapsed time using a timer function. The measurement result is used in the later-described display control in step S107. After step S203, the processing in FIG. 6 ends, and the processing proceeds to step S104 in FIG. 5.

In step S104 in FIG. 5, the HUD control unit 218 acquires the driver's viewpoint. FIG. 7 is a flowchart showing processing for acquiring the viewpoint in step S104. In step S301, the HUD control unit 218 analyzes the driver's line of sight. For example, the in-vehicle recognition unit 203 of the control unit 200 may analyze the driver's line of sight using the in-vehicle recognition camera 209 and the in-vehicle recognition sensor 210, and the HUD control unit 218 may acquire the recognition results.

In step S302, the HUD control unit 218 specifies the coordinates of the viewpoint in the visual field region 300 based on the results of analysis in step S301. For example, the HUD control unit 218 specifies the coordinates of the viewpoint in the visual field region 300 based on the captured image data obtained by the external recognition camera 207 that corresponds to the visual field region 300. After step S302, the processing in FIG. 7 ends, and the processing proceeds to step S105 in FIG. 5.

In step S105 in FIG. 5, the HUD control unit 218 determines whether or not the region of interest displayed in step S103 overlaps with the viewpoint acquired in step S104. For example, the determination in step S105 may be performed based on the coordinates of the region of interest specified in step S202 and the viewpoint coordinates specified in step S302. If, in step S105, it is determined that the displayed region of interest overlaps with the acquired viewpoint, display control in step S106 is performed, and if, in step S105, it is determined that the displayed region of interest does not overlap with the acquired viewpoint, display control in step S107 is performed.

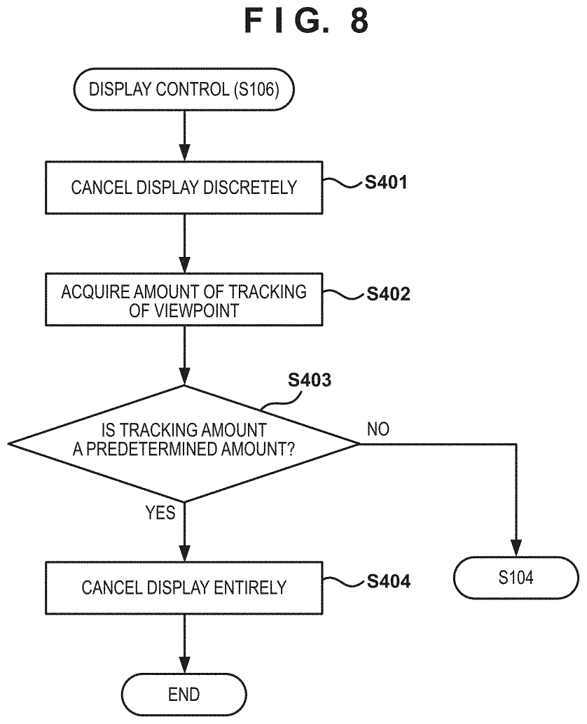

FIG. 8 is a flowchart showing the display control processing in step S106. In step S401, the HUD control unit 218 specifies an overlapping region for which it is determined that the displayed region of interest overlaps with the acquired viewpoint, and cancels the display control that has been performed in step S103. Here, the region for which it is determined that the displayed region of interest overlaps with the acquired viewpoint corresponds to the viewpoint region 304 in FIG. 4. For example, the HUD control unit 218 specifies a predetermined region that includes the viewpoint coordinates specified in step S302, e.g., a circular region with a predetermined radius, and cancels the identifiable display (e.g., translucent display) in this region. As a result, the driver can recognize that the translucent display at the point at which the driver places a viewpoint has disappeared. Also, in step S401 after viewpoint tracking has been performed, an outline region of a trace of the predetermined region that includes the viewpoint coordinates (e.g., a circular region corresponding to the viewpoint 303) having moved is specified as the overlapping region (which corresponds to the viewpoint region 304).

In step S402, the HUD control unit 218 acquires the amount of tracking of the viewpoint. The amount of tracking of the viewpoint corresponds to the amount of movement of the viewpoint 303 in FIG. 4, that is, the viewpoint region 304 that is the overlapping region. If the driver places the viewpoint at the region of interest for the first time, the amount of tracking of the viewpoint acquired in step S402 is an initial value. The initial value may be zero, for example.

In step S403, the HUD control unit 218 determines whether or not the amount of tracking acquired in step S402 has reached a predetermined amount. Here, the predetermined amount may be, for example, the area corresponding to a predetermined ratio of the area of the region of interest. If it is determined that the amount of tracking has reached a predetermined amount, in step S404, the HUD control unit 218 cancels the display control performed in step S103 for the entire region of interest. As a result, the driver can recognize that the translucent display of the region of interest at which the driver has placed a certain amount of viewpoint has completely disappeared. After step S404, the processing in FIG. 8 ends, and the processing is repeated from step S101 in FIG. 5.

If, in step S403, it is determined that the amount of tracking has not reached the predetermined amount, the processing is repeated from step S104. For example, if the driver has placed a viewpoint at the region of interest, and the overlapping region has not yet reached the predetermined amount even after the viewpoint has been moved within the region of interest, the viewpoint is tracked due to the processing being repeated from step S104. In this case, for example, an outline region of a trace of a predetermined region that includes the viewpoint coordinates (e.g., a circular region corresponding to the viewpoint 303) having moved is specified as the overlapping region, as mentioned above.

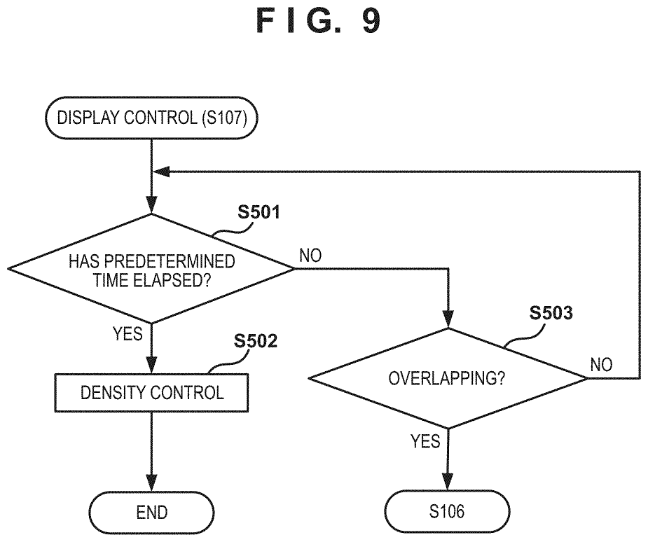

FIG. 9 is a flowchart showing the display control processing in step S107. The processing proceeds to step S107 in the case where, for example, the regions 301 and 302 in FIG. 3 are displayed but the driver has not placed a viewpoint at these regions.

In step S501, the HUD control unit 218 determines whether or not a predetermined time has elapsed, based on the measurement result obtained by the timer function. Here, if it is determined that the predetermined time has elapsed, in step S502, the HUD control unit 218 increases the display density of the region of interest displayed in step S103. This configuration can urge the driver to pay attention to the region of interest. The display control in step S502 is not limited to density control, and any other display control may be performed. For example, the region of interest displayed in step S103 may be flashed. After step S502, the processing in FIG. 9 ends, and the processing is repeated from step S105 in FIG. 5.

On the other hand, if, in step S501, it is determined that the predetermined time has not elapsed, in step S503, the HUD control unit 218 determines whether or not the region of interest displayed in step S103 overlaps with the viewpoint acquired in step S104. For example, the determination in step S503 may be performed based on the coordinates of the region of interest specified in step S202 and the viewpoint coordinates specified in step S302. If, in step S503, it is determined that the displayed region of interest overlaps with the acquired viewpoint, the display control in step S106 is performed, and if, in step S503, it is determined that the displayed region of interest does not overlap with the acquired viewpoint, the processing is repeated from step S501.

As described above, according to the present embodiment, when a vehicle travels in a scene in which a point that requires attention, such as an intersection, is present, this region is identifiably displayed on the windscreen by the head-up display. If the driver has not placed a viewpoint at this region for a predetermined time, the display mode of this region further changes. This configuration can effectively urge the driver to pay attention. If the driver places a viewpoint at this region, the identifiable display is canceled in accordance with the amount of movement of the viewpoint. This configuration can motivate the driver to sufficiently pay attention.

### Second Embodiment

The second embodiment will be described below regarding differences from the first embodiment. In the first embodiment, after the current position of the vehicle 1 has been acquired in step S101, if, in step S102, it is determined not to display the region of interest, the processing is repeated from step S101, as described with reference to FIG. 5. In the present embodiment, after step S101, risk determination is performed regarding the external environment of the vehicle 1. Here, the risk determination refers to, for example, determination of the possibility that an oncoming vehicle will approach the vehicle 1. For example, if the vehicle 1 needs to avoid approach of another vehicle or a moving object, a warning is displayed without performing the processing in step S103 and the subsequent steps.

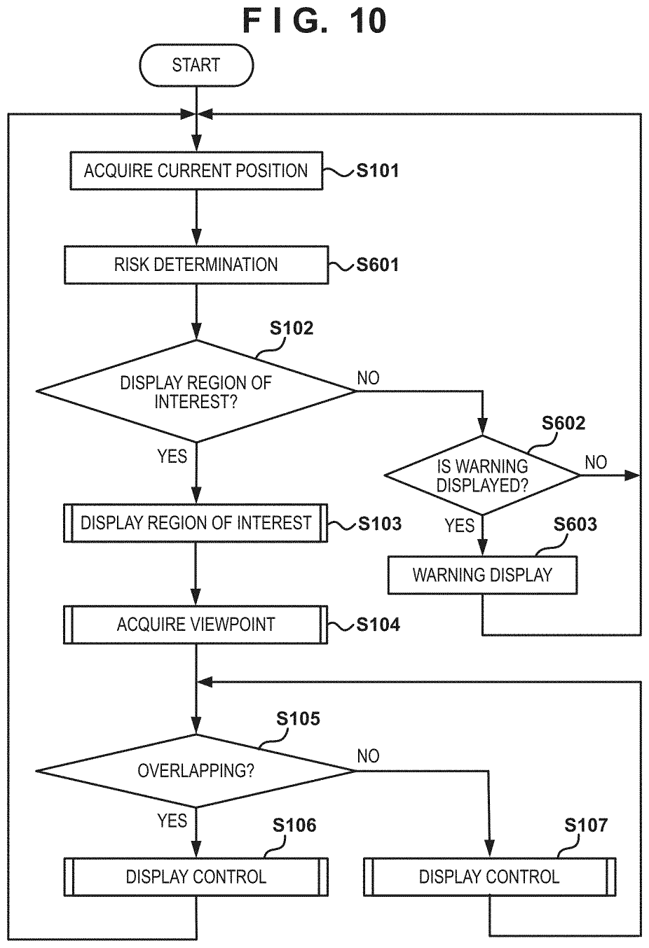

FIG. 10 is a flowchart showing display control processing in the present embodiment. For example, the processing in FIG. 10 is realized by the HUD control unit 218 loading a program from a storage area of a ROM or the like and executing the program. The processing in FIG. 10 is started upon the vehicle 1 starting traveling.

Step S101 is as described in the first embodiment, and a description thereof is omitted accordingly. In the present embodiment, after the current position of the vehicle 1 has been acquired in step S101, in step S601, the HUD control unit 218 performs risk determination. For example, the risk determination may be performed by determining the possibility that a traveling path of another vehicle or a moving object will overlap the traveling path of the vehicle 1, based on the recognition result obtained by the external recognition unit 201. Also, for example, the risk determination may be performed by determining the possibility that a dead angle region for the vehicle 1 will occurs due to another vehicle. Also, for example, the risk determination may be performed based on a road condition such as freezing, or weather conditions such as rainfall and heavy fog. Any of various indexes may be used as the result of the risk determination, and for example, the margin to collision (MTC) may be used.

In the present embodiment, in step S102, the HUD control unit 218 first determines whether or not to display a region of interest, based on the result of the risk determination in step S601. For example, if approach of another vehicle is recognized and the MTC is smaller than or equal to a threshold, the HUD control unit 218 determines not to display a region of interest. On the other hand, if, based on the risk determination result, it is determined to display a region of interest, it is further determined whether or not to display a region of interest, based on the current position of the vehicle 1 that is acquired in step S101.

If, in step S102, it is determined not to display a region of interest, in step S602, the HUD control unit 218 determines whether or not to display a warning. In the determination in step S602, for example, it is determined to display a warning if, in step S102, it is determined not to display a region of interest based on the risk determination result. It is determined not to display a warning if, in step S102, it is determined not to display a region of interest based on the current position of the vehicle 1. If, in step S602, it is determined not to display a warning, the processing is repeated from step S101. If, in step S602, it is determined to display a warning, the processing proceeds to step S603.

In step S603, the HUD control unit 218 generates display data for displaying a warning, and controls the HUD 219 so as to display the display data on the windscreen. Here, the display data may be, for example, data indicating the direction of another approaching vehicle or moving object. Alternatively, the display data may be data indicating a regional display that surrounds an approaching another vehicle or moving object in the visual field region 300. If, after such a warning has been displayed, it is detected that the driver has placed a viewpoint at an area near the warning display, the warning display may be canceled. After step S603, the processing is repeated from step S101.

As described above, according to the present embodiment, if, for example, a risk such as collision with another vehicle or a moving object is determined while the vehicle 1 is traveling, a notification of the risk is displayed without displaying a region of interest. This configuration can more effectively make the driver recognize the occurrence of risk.

### Third Embodiment

The third embodiment will be described below regarding differences from the first and second embodiments. The first and second embodiments have a configuration in which a region of interest is displayed at a timing at which, in step S102, it is determined to display the region of interest. In the present embodiment, a region of interest is displayed at a timing at which it is decided, based on an internally-set region of interest, that the driver has not placed a viewpoint at the region of interest. With this configuration, in the case of a driver who is more likely to place a viewpoint at a region of interest, such as a skilled driver, the frequency of executing HUD display on the windscreen can be reduced, so that the driver can focus on driving.

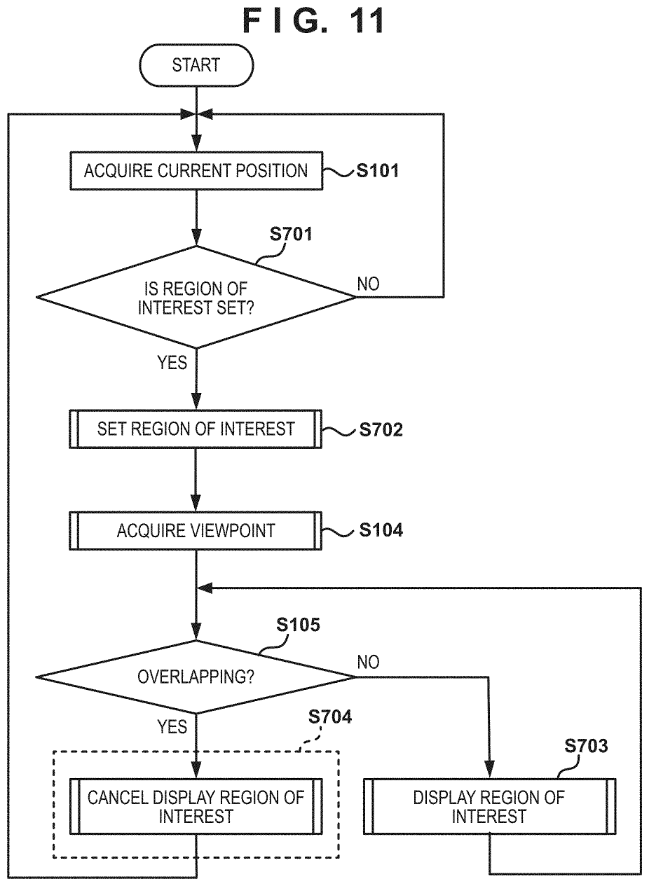

FIG. 11 is a flowchart showing display control processing in the present embodiment. For example, the processing in FIG. 11 is realized by the HUD control unit 218 loading a program from a storage area of a ROM or the like and executing the program. The processing in FIG. 11 is started upon the vehicle 1 starting traveling.

Step S101 is as described in the first embodiment, and a description thereof is omitted accordingly. In the present embodiment, after the current position of the vehicle 1 has been acquired in step S101, in step S701, the HUD control unit 218 determines whether or not to set a region of interest, based on the current position of the vehicle 1 acquired in step S101. The criteria for determining whether or not to set a region of interest is the same as the determination criteria in step S102 in the first embodiment. If, in step S701, it is determined not to set a region of interest, the processing is repeated from step S101. If, in step S701, it is determined to set a region of interest, the processing proceeds to step S702.

In step S702, the HUD control unit 218 sets a region of interest. The region of interest to be set corresponds to the regions 301 and 302 in FIG. 3. However, unlike the first embodiment, the region of interest is not displayed at this timing. That is to say, in step S702, the processing in steps S201 and S202 in FIG. 6 is performed, and the processing in step S203 is not performed.

After step S702, the processing in steps S104 and S105 is performed. Steps S104 and S105 are as described in the first embodiment, and a description thereof is omitted accordingly. In step S105, it is determined whether or not the region of interest set in step S702 overlaps with the viewpoint acquired in step S104. If, in step S105, it is determined that the set region of interest overlaps with the acquired viewpoint, the processing is repeated from step S101. That is to say, in the present embodiment, if the driver places a viewpoint at a region that requires attention, HUD display on the windscreen is not executed. On the other hand, if, in step S105, it is determined that the set region of interest does not overlap with the acquired viewpoint, the processing proceeds to step S703.

In step S703, the HUD control unit 218 displays the region of interest set in step S702. In step S703, the same processing as step S203 in the first embodiment is performed. This configuration can urge the driver to pay attention to the region of interest, similarly to the first embodiment. After step S703, the processing is repeated from step S105.

After the processing in step S703 has been performed, if, in step S105, it is determined that the set region of interest overlaps with the acquired viewpoint, in step S704, the HUD control unit 218 performs display control for the region of interest displayed in step S703. For example, in step S704, the processing may be repeated from step S101 such that the same processing as step S106 in the first embodiment is performed. Alternatively, a configuration may be employed in which, if, in step S105, it is determined that the set region of interest overlaps with the acquired viewpoint, the display of the region of interest is entirely canceled and the processing is repeated from step S101, rather than entirely canceling the display of the region of interest if the overlapping region reaches a predetermined amount. This configuration can reduce the frequency of displaying a region of interest to a skilled driver.

As described above, according to the present embodiment, a region of interest is displayed at a timing at which it is decided that the driver has not looked at the set region of interest. This configuration can reduce the frequency of executing HUD display on the windscreen and allow the driver to focus on driving in the case of a driver who is more likely to look at the region of interest, such as a skilled driver.

A setting may be made to switch between the operations in the first, second, and third embodiments. For example, this switching is performed on a user interface screen displayed on the display device 216, and the control unit 200 communicates the selected operation mode to the HUD control unit 218.

### SUMMARY OF EMBODIMENTS

A display control apparatus of one of the above embodiments includes: a display control unit (218) configured to display an image such that the image is superimposed on a visual field region of a driver of a vehicle; and a detection unit (209, 210, 203, S104) configured to analyze a line of sight of the driver and detect a viewpoint of the driver in the visual field region that is obtained as a result of the analysis, wherein the display control unit subjects a predetermined region in the visual field region to display control, and based on a result of determination of overlapping between the predetermined region in the visual field region and the viewpoint of the driver detected by the detection unit, if the overlapping satisfies a condition, the display control unit changes a mode of the display of the image (S106).

This configuration can effectively urge the driver to closely observe the predetermine region (region of interest) in the visual field region.

The image is an image (301, 302) superimposed on the predetermined region. The display control unit executes identifiable display such that the image can be identified.

With this configuration, the predetermined region can be more readily recognized by the driver by, for example, displaying the predetermined region in a lightly colored manner.

The identifiable display is executed if the predetermined region is specified in the visual field region (S103). The identifiable display is executed if the predetermined region is specified in the visual field region, and the viewpoint of the driver is detected at a position different from the predetermined region (S703).

With this configuration, upon the predetermined region being recognized, the predetermined region is identifiably displayed, and thus the predetermined region can be promptly displayed. In addition, the frequency of displaying the predetermined region can be reduced for a skilled driver, for example.

As the condition, if the overlapping is detected, the display control unit cancels the identifiable display that has been executed for a portion of the image that corresponds to the overlapping (S401). As the condition, if the overlapping exceeds a predetermined amount, the display control unit cancels the identifiable display that has been executed for the image (S404, S704).

This configuration can effectively make the driver recognize that the driver has placed a viewpoint at the predetermined region.

If, after the identifiable display has been executed, the viewpoint of the driver is detected at a position different from the predetermined region, the display control unit changes a mode of the identifiable display. The display control unit changes the mode of the identifiable display by changing density of the image (S502).

With this configuration, if the driver has not placed a viewpoint at the predetermined region, the driver can be effectively urged to closely observe the predetermined region in the visual field region.

Also, the display control apparatus further includes a determination unit (S601) configured to determine a risk outside the vehicle, wherein, depending on a result of the determination by the determination unit, the display control unit displays, as the image, an image for warning the driver about the risk such that the image is superimposed on the visual field region (S603). With this configuration, if, for example, a moving object or another vehicle is approaching a self-vehicle, a warning indicating the approach can be displayed. Furthermore, if the driver looks at the point of this approach, this warning display can be canceled.

The invention is not limited to the foregoing embodiments, and various variations/changes are possible within the spirit of the invention.

What is claimed is:

1. A display control apparatus comprising:
a display control unit configured to display an image such that the image is superimposed on a visual field region of a driver of a vehicle; and
a detection unit configured to analyze a line of sight of the driver and detect a viewpoint of the driver in the visual field region that is obtained as a result of the analysis,
wherein the display control unit subjects a predetermined region in the visual field region to display control, and
based on a result of determination of overlapping between the predetermined region in the visual field region and the viewpoint of the driver detected by the detection unit, if the overlapping satisfies a condition, the display control unit changes a mode of the display of the image.

2. The display control apparatus according to claim 1,
wherein the image is an image superimposed on the predetermined region.

3. The display control apparatus according to claim 2,
wherein the display control unit executes identifiable display such that the image can be identified.

4. The display control apparatus according to claim 3,
wherein the identifiable display is executed if the predetermined region is specified in the visual field region.

5. The display control apparatus according to claim 3,
wherein the identifiable display is executed if the predetermined region is specified in the visual field region, and the viewpoint of the driver is detected at a position different from the predetermined region.

6. The display control apparatus according to claim 4,
wherein, as the condition, if the overlapping is detected, the display control unit cancels the identifiable display that has been executed for a portion of the image that corresponds to the overlapping.

7. The display control apparatus according to claim 4,
wherein, as the condition, if the overlapping exceeds a predetermined amount, the display control unit cancels the identifiable display that has been executed for the image.

8. The display control apparatus according to claim 3,
wherein if, after the identifiable display has been executed, the viewpoint of the driver is detected at a position different from the predetermined region, the display control unit changes a mode of the identifiable display.

9. The display control apparatus according to claim 8,
wherein the display control unit changes the mode of the identifiable display by changing density of the image.

10. The display control apparatus according to claim 1, further comprising
a determination unit configured to determine a risk outside the vehicle,
wherein, depending on a result of the determination by the determination unit, the display control unit displays, as the image, an image for warning the driver about the risk such that the image is superimposed on the visual field region.

11. A display control method to be executed by a display control apparatus, the method comprising:
displaying an image such that the image is superimposed on a visual field region of a driver of a vehicle; and
analyzing a line of sight of the driver and detecting a viewpoint of the driver in the visual field region that is obtained as a result of the analysis,
wherein a predetermined region in the visual field region is subjected to display control, and
based on a result of determination of overlapping between the predetermined region in the visual field region and the detected viewpoint of the driver, if the overlapping satisfies a condition, a mode of the display of the image is changed.

12. A non-transitory computer-readable storage medium storing a program for causing a computer to perform functions of:
displaying an image such that the image is superimposed on a visual field region of a driver of a vehicle; and
analyzing a line of sight of the driver and detecting a viewpoint of the driver in the visual field region that is obtained as a result of the analysis,
wherein a predetermined region in the visual field region is subjected to display control, and
based on a result of determination of overlapping between the predetermined region in the visual field region and the detected viewpoint of the driver, if the overlapping satisfies a condition, a mode of the display of the image is changed.
